(19) United States
(12) Patent Application Publication
(10) Pub. No.: US 2012/0095935 A1
(43) Pub. Date: Apr. 19, 2012

(54) METHOD FOR MANAGING THE INBOUND FREIGHT PROCESS OF THE SUPPLY CHAIN ON BEHALF OF A RETAILER DISTRIBUTION NETWORK

(76) Inventors: W. John Mowat, Toronto (CA); Christine E. Hart, Toronto (CA); Tara Mowat, Aurora (CA); Melanie Mowat, Aurora (CA); Katie Mowat, Toronto (CA)

(21) Appl. No.: 12/953,732

(22) Filed: Nov. 24, 2010

(30) Foreign Application Priority Data
Oct. 15, 2010 (CA) 2,717,666

(51) Int. Cl. G06Q 10/00

(52) U.S. Cl. 705/333

(57) ABSTRACT

A method for managing the transportation and logistics of an inbound freight process on behalf of a retail distribution network is provided. A purchase order is processed for a scheduled inbound shipment of a vendor's goods, including a delivery date on which the shipment is required by the retail distribution network. An optimal carriage arrangement is determined so as to meet the delivery date requirement on a just-in-time basis, including proactive reduction of order cycle time where opportunity exists. A pickup appointment is scheduled with the vendor, and notified to the vendor and the retail distribution network. An available carrier is assigned, and notified as to the pickup appointment and the delivery date requirement. Delivery of the order by the carrier is arranged, and the status of the order is monitored. The retail distribution network and the vendor are notified of a successful delivery meeting the delivery date requirement, or if there is a service failure, the resolution thereof.

### CLAIM OF PRIORITY

The present patent application claims the benefit of priority under 35 U.S.C. §119 to Canadian Patent Application No. 2,717,666, filed Oct. 15, 2010, the entire contents of which are incorporated herein by reference in their entirety.

### FIELD OF THE INVENTION

The invention relates to supply chain management, and more particularly, to the planning and management of the transportation and logistics of an inbound freight process for a retail distribution network.

### BACKGROUND

A retailer sells goods to consumers. Consumers seldom think about where those goods come from or by what process they arrive at the retailer's stores. Retailers have great sophistication in finding sources of goods and negotiating prices with vendors, but they often lack the same sophistication in the art of managing transportation of those goods from the vendors—the art of transportation and logistics planning and management. A retail chain with multiple geographically disparate locations (or a retail distribution network) may have hundreds of stores and draw from hundreds or even thousands of individual vendors. There is enormous complexity in planning and managing transportation of all those goods. It may usefully be compared to writing the sheet music and then conducting a symphony.

Historically, the transportation and logistics of the inbound freight aspect of the supply chain has been “controlled or managed” by the vendors, with each vendor taking responsibility for the planning and managing of the “prepaid” transport of its goods to the retailer. This approach, while long standing, has increasingly been seen (by retailers) to be not sufficiently cost effective (due to use of “less than a truckload” (LTL) quantity shipments) and prone to hidden costs from insufficient “just-in-time” (JIT) deliveries, uneven use of retailers' receiving capacity at its distribution centers (DC's), late shipments, etc.

While retailers have introduced more stringent logistics protocols and introduced punitive non-compliance measures (e.g. for late shipments), there has continued a degree of dissatisfaction by retailers with the cost effectiveness of the inbound freight programs.

The use by some vendors of 3^{rd} party logistics providers to outsource their warehousing and shipments, while helpful to both the vendors and retailers, has not addressed the aspiration of the retailers to achieve lower costs and 100% levels of on-time delivery.

Furthermore, some retailers have tried, but with limited success, to exert more control over the inbound freight process by changing the freight payment terms and moving from “vendor prepaid” to “retailer collect” inbound freight and, in turn, extract for their benefit lower costs and improved on-time delivery.

The retailer is still looking for an inbound freight program which is lower in cost, while being capable of achieving consistently 100% on-time delivery without higher costs to the vendor and/or the carriers (since such higher costs would likely be resisted by vendors and/or “passed on” to the retailer in the future). There is a need for a better approach to the planning and management of the inbound freight process to yield lower operating and overhead costs and improved on-time delivery for the benefit of the retailer as well as the benefit of the vendor and carrier community so as to secure their “buy in” and on going commitment.

### SUMMARY OF THE INVENTION

The invention addresses the needs of the retailer without the retailer having to take direct “control” of the planning and management of the inbound freight process. A “supply chain manager” is provided for the planning and management of the transportation and logistics of the inbound freight process.

The invention relates to the inbound freight process, and specifically the process for inbound pickup and delivery of consumer goods on their way inbound to a retail distribution network with multiple distribution centers and/or the retail stores. The present method presumes an overarching manager of the process who acts in partnership with (and with the endorsement of) the retail distribution network (retailer) but is independent (not an in-house logistics department). This “supply chain manager” also acts in cooperation with the vendors and carriers to handle all aspects of the day-to-day planning and management of the transportation and logistics of the inbound freight process. The “supply chain manager” is not a consultant nor does it take title to the transported goods.

The manager (i.e. the “supply chain manager”) takes on various roles. These are usefully categorized as follows:
Acting as “carrier” from the vendor's perspective (i.e. taking care of the carrier arrangements). The vendor pays the “norm” or its best negotiated freight rate. In either case, the responsibility for on time delivery rests with the manager. The vendor gets the benefits of i) relief from exposure to retailer imposed non-compliance penalties (e.g. late shipment penalties) and ii) the overheard savings (i.e. from reduced need for staffing in its shipping and accounting departments to administer shipments, claims, etc).
Acting as “manager of inbound freight transportation and logistics” from the perspective of the retail distribution network (i.e. retailer). The retailer gets the benefits of i) increased inventory turns, from a shorter order/ship/delivery cycle; ii) productivity gains from increases in efficiency in its DC receiving department; and iii) “gain-sharing” with the manager.
Acting as the de facto “customer” of the carrier actually moving the goods. The carrier, in exchange for providing lower freight rates pursuant to the manager's competitive bid negotiation process, and re-engineered activity, gets the benefits of i) increased pick up/delivery opportunities since the manager now oversees and manages the entire inbound freight process; ii) increased asset productivity/load capacity utilization; and iii) reduced wait-times at the DC receiving yards.

Due to the independence of the supply chain manager (i.e. not being asset-based or in direct competition with any of the parties), and its multifarious position (as illustrated by the roles above), the manager is uniquely positioned to balance the interests of retailer, vendor and carrier (without disturbing the terms of their existing relationships, e.g. by changing the ownership/title-transfer terms or payment terms). The supply manager is uniquely dedicated to the goal of ensuring the highest level of overall efficiency in the system and providing for satisfaction of the expectations of each party.

The invention relates to the day-to-day management of transportation and logistics on behalf of the retail distribution network. However, to understand why that process works among the specific parties, there are certain contractual arrangements that must first be understood.

The retail distribution network preferably has an underlying partnership agreement with the supply chain manager. The partnership agreement may provide for a “gain-sharing” arrangement. In effect, the gain-sharing arrangement is a form of arbitrage with the difference between the vendors' normal prepaid freight cost and the manager's lower freight costs (net of operating costs) being “gain-shared” with the retailer. The manager assumes responsibility for billing/collecting freight costs from the vendor and for auditing/paying carrier freight bill. The manager's arrangement with the retail partner may also include:
budgets for staff, administrative and operating costs;
targets for transportation spending to forecast projected savings/profit to be “gain-shared”;
terms stipulating the installation of the manager's own personnel at each retail distribution network center, so that they work side by side with the retailer's staff and service providers (but are fully responsible for the inbound freight program).

Data provided by the retailer is used by the manager to forecast the capacity needs and transportation requirements thereby enabling identification and selection of carriers to minimize cost and cut order cycle times. Parameters for the selection of carriers include origin and destination of goods, inventory/order volume forecasts, types of goods, vendor lead time constraints, retail distribution network centre facilities and receiving practices, carrier availability (among others). Since the manager is considered the “carrier” (from the vendor's perspective), the vendor receives a freight invoice (based on the vendor's prepaid freight rates) from and pays the manager and makes pickup and delivery arrangements with the manager as they would otherwise with any other carrier.

The manager preferably confirms (or negotiates) upfront prepaid freight rate agreements with the vendors (including by weight, cube, skid/lifts). The manager's marketing material may be used by the manager's sales staff and retailer inventory and supply chain management to sell vendors on the merits of the program and encourage buy-in and participation.

The manager preferably works with retailer inventory and supply chain management to identify prioritized list of vendor prospects to be recruited into the inbound freight management program.

The manager preferably performs a study to understand vendor constraints with respect to order lead times, packing methods, loading, labelling and documentation standards so as to be able to assign optimal carrier arrangements, and also, facilitates the identification of areas of non-compliance with retailer distribution network centre requirements, correcting issues or establishing specialized receiving procedures. To the carrier, the manager is the “customer”. The manager assumes the role that the vendor or retailer would typically undertake. The manager is fully responsible for tendering and signing agreements for transportation based on needs established during the transportation demand planning and forecasting study. If the manager utilizes the dedicated fleet of the retailer to perform pickups, the manager will pay the retailer and in turn create a significant cost recovery as well as contribute positively to “Green” initiatives for the retailer in reducing its “carbon footprint”. The manager preferably educates and ensures carrier compliance with retailer distribution network centres.

According to a first aspect of the invention, a method is provided for managing the transportation and logistics of an inbound freight program on behalf of a retail distribution network. A purchase order is processed for a required inbound shipment of a vendor's goods. The purchase order includes a date on which the shipment is required for delivery by the retail distribution network. An optimal carriage arrangement is then determined to meet the date requirement on a just-in-time basis, including proactive reduction of order cycle time where opportunity exists. A pickup appointment, based on the required delivery date at the retail distribution network center, is scheduled with the vendor. This appointment is notified to the vendor and the retail distribution network. An available carrier is assigned, and the carrier is notified as to the pickup appointment and the scheduled delivery date. Delivery of the order by the carrier is arranged. The pickup and delivery of the order is monitored. The retail distribution network center and the vendor are notified of a successful delivery meeting the date requirement. Alternatively, the retail distribution network center and the vendor are notified if there is a service failure such that the scheduled delivery date cannot be met and what “recovery” arrangements are being undertaken.

To optimize the carriage arrangement, multiple purchase orders may be consolidated together according to the manager's preset optimization rules as well as the use of backhaul transportationA specific dock availability window is assigned at which the shipment will be available at the vendor's dock to meet the scheduled delivery date.

Retail distribution network center and vendor visibility is provided for the current status of the pickup and delivery of the order.

Delivery to the retail distribution network centre is scheduled. If desirable in light of the delivery date requirement, the manager may institute such delivery mechanisms as off docking and cross docking so as to best assure meeting the scheduled delivery date at the lowest cost.

In the event of a service failure, the method further includes resolution of the service failure and notification of the retail distribution network and the vendor of the resolution.

The financial arrangements of the transaction deserve separate mention. The method may further comprise facilitating negotiation of a cost of shipment, or retrieving a prenegotiated rate for the shipment. Preferably, the shipment cost (i.e. freight cost) is prepaid by the vendor. Preferably, the vendor and the retail distribution network have a pre-existing contractual relationship.

### BRIEF DESCRIPTION OF THE FIGURES

FIG. 1 is a flow diagram comparing the normal flow to inbound freight management program flow (for local truck-load vendor pickup).

FIG. 2 is a flow diagram comparing the normal flow to inbound freight management program flow (for less than truck-load vendor pickup and delivery to out of town DC).

FIGS. 3A and 3B are flow diagrams comparing the normal delivery from DC to vendor with backhaul as used in the present method.

FIGS. 4A and 4B are flow diagrams comparing the normal DC receiving and shipping with cross-docking according to the present method.

FIGS. 5A and 5B are flow diagrams comparing the normal supply chain steps for delivery to stores from a vendor with off-docking supply chain steps for delivery to stores from a vendor.

FIG. 6 is a flow diagram illustrating event management according to an embodiment of the present method.

FIG. 7A is a flow diagram illustrating the program foundation phase of an inbound freight management program.

FIG. 7B is a flow diagram illustrating the daily processing by the supply chain manager according to the present method.

FIG. 8A is a sample screen shot of a location selection screen on a vendor pickup notification portal.

FIG. 8B is a sample screen shot of a detail confirmation screen on a vendor pickup notification portal.

FIG. 8C is a sample shipment routing report.

FIG. 8D is a sample carrier notification report.

FIG. 8E is a sample issue notification template.

### DETAILED DESCRIPTION

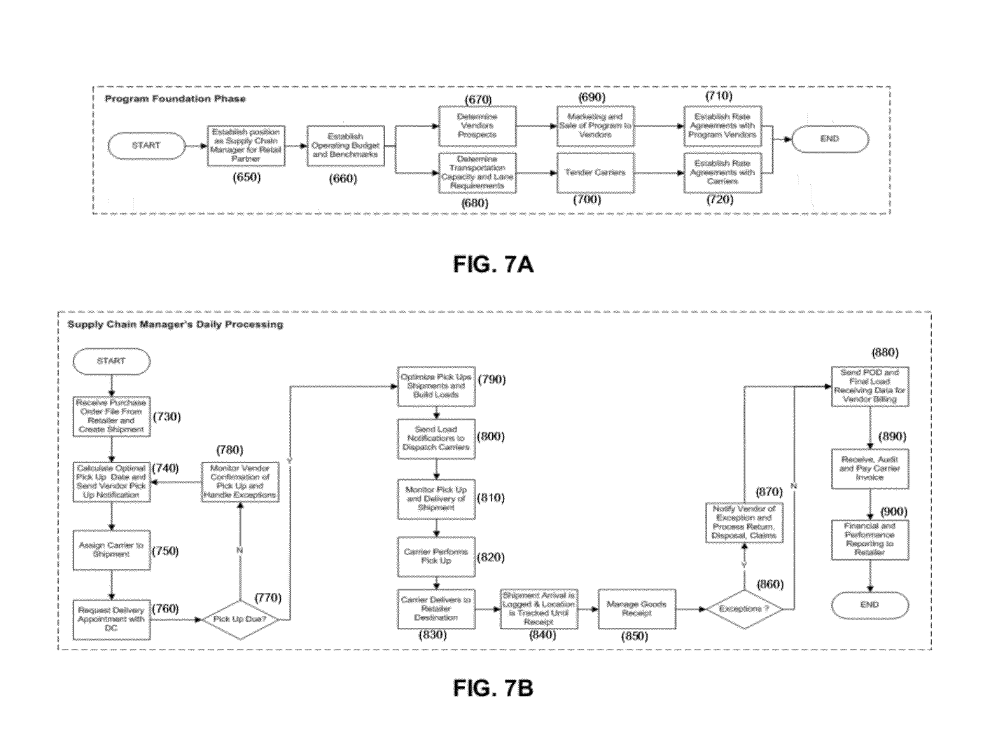

FIG. 7A illustrates the underlying foundation of the inbound freight management program. As shown, the partnership between the retail partner and the supply chain manager is first established 650. The two together establish an operating budget and benchmarks 660.

On the vendor side, vendor prospects are identified for inclusion in the program (or the retailer's vendors are moved into the program as a mandatory step) 670. The vendors may be pitched and sold on the program (either by the retailer, or by the manager) 690. The manager establishes rate agreements with each program vendor 710.

On the carrier side, the manager (in consultation with the retailer, or through a study of the retailer's requirements) identifies transportation capacity and lane requirements 680 (i.e. all of the city-to-city or hub-to-hub paths of transport required for the retailer's goods). The manager selects and tenders carriers 700 for those requirements. The manager establishes rate agreements with the carriers 720.

Turning to FIG. 7B, the basic flow of orders is illustrated through to delivery, payment and reporting. Purchase orders are received from the retailer (e.g. downloaded from electronic data system of the retailer) and a “shipment” is created in the manager's system 730. An optimal pickup date is then calculated (based on when the goods are required at the retailer's DC and where the vendor is located), and a vendor pickup notification is sent 740. The manager then assigns a carrier to the shipment 750, and requests a delivery appointment with the DC 760. When the pickup is due 770, the manager monitors to receive the vendor's confirmation of the pickup date. If there are any exceptions (e.g. the vendor cannot meet the pickup date, or needs an earlier pickup date), these are handled by the manager 780.

Each shipment is reviewed individually and also within the context of other shipments scheduled for pickup on the same day in the same area. Any optimizations of the loads are built at this stage. For example, the optimization step considers:
(1) Are there any other loads that could be consolidated with this one to better fill the truck?
(2) Could this load be put onto a truck moving through the area (e.g. a truck on his way back from the DC)?

Load notifications are sent to the dispatch carriers 800.

The manager monitors 810 as the pickup 820 and delivery 830 of the shipment proceeds. At the DC (or another retailer destination), the shipment arrival is logged and the location is tracked until received by the retailer 840. The goods receipt is managed 850. If there are exceptions 860, the vendor is notified and any returns, disposals or claims are initiated (or managed) by the manager 870. The proof of delivery (POD) and final load receiving data are sent for vendor billing 880. When the carrier submits his invoice, this is received, audited and paid by the manager 890. At predetermined intervals, the manager provides financial and performance reports to the retailer 900.

We now look at this daily process and the underlying logic (and predetermined rules) in some more detail. The manager preferably establishes standard data set, process and scheduling for the exchange of purchase order (PO) information with retail distribution network centre systems for the purposes of creating shipments in the transportation management system (TMS). The manager creates predefined “rules” to calculate optimal delivery appointment times to ensure just-in-time good receipt of goods with parameters including origin of goods, criticality of order, type of goods, warehouse staffing and shifts. The manager proposes the delivery appointment times to the retail distribution network centres, which in turn confirm the appointment times. The manager then notifies and works through any required changes to PO due dates with the retailer and vendor as needed. The manager creates predefined rules for determining optimal date for pick up of goods from the vendor location to meet PO delivery due date with parameters including origin of goods, carrier service levels and cost, vendor constraints such as lead time to assemble shipment, warehouse hours, shipment size, consolidation opportunities as appropriate. Vendors are notified about the pickup date of the purchase order (for example, through a partner portal application). The vendors then confirm the pickup date, lift counts and special handling needs back to the manager. The manager creates predefined rules (hierarchy) for assigning carriers to transport goods taking into account backhaul and consolidation opportunities to lower costs.

Daily dispatches are sent to carrier partners for forthcoming assigned pickups, including pick up dates, special instructions for pick up and handling, delivery appointment dates and times. The manager resolves any issues that may arise if carrier does not have ability to perform the service and assigns alternate carriers based on predefined hierarchy.

Customer service department at head office and operational staff are preferably positioned at key points at the retail distribution network centres ensure that service levels of carriers and receiving staff can be monitored. Upon arrival at the DC, carriers hand over paperwork for pickups to the manager's personnel for validation, scanning and logging that the goods have arrived in the yard. (This paperwork would normally be sent to retailer's receiving department.) The manager's personnel then give the paperwork over to receiving staff of the warehouse as needed to ensure a steady stream of goods receipt and to ensure that no loads are left in yard that cannot be tracked and accounted for by the manager. The manager makes arrangements, as need be, so that carriers can drop trailers into the yard and avoid incurring detention and demurrage charges for the vendor if there is any warehouse receiving backups or if delivery was required to be made outside of the scheduled appointment window. The manager makes alternative delivery appointments, as need be, with the retailer distribution network centres.

The manager keeps track of the inventory of purchase orders on trailers in the yard and arranges shunting of trailers into appropriate doors to meet retailer priorities (this function is especially important when the warehouses get behind on receiving). The manager arranges pick up of empty off-loaded trailers from the retailer's yard to avoid charges from carriers. The manager coordinates, as need be, cross-docking or off-docking of shipments. Retailer receiving staff report to the manager with respect to “over, short or damaged” goods (“OS&D”) upon completion of receiving and verifying purchase orders. The manager takes responsibility to notify the vendor and, on vendor's request, will manage returns and/or disposal of any OS&D freight.

The manager logs, investigates and manages claims for missing or damaged freight with the carriers and pays or settles with the vendor for legitimate claims as the carrier normally would be responsible for doing this and then claims this money back from the responsible carrier as reimbursement. The manager sets up and manages overflow or special event warehouses (including requisite IT applications needed to manage the process) on behalf of the retailer and takes responsibility for transport of goods to the warehouse, receipt, building of store or distribution network centre shipments and delivery to final destination (examples wrap, cosmetics, imports, store fixtures).

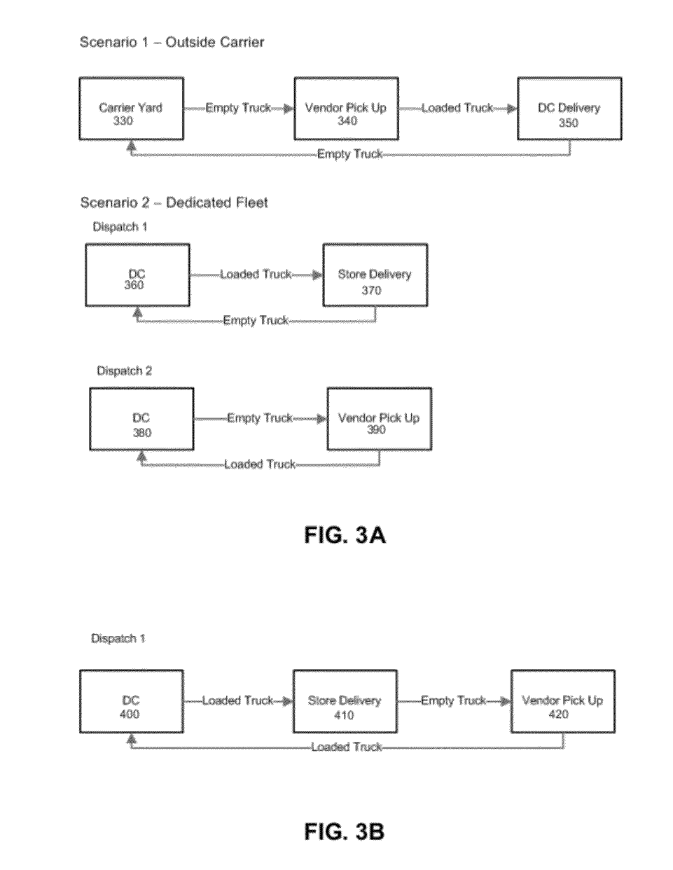

The manager invoices the vendor at the upfront agreed prepaid rate, and manages the full process of AR and collections. Likewise, the manager receives, audits, approves and issues for payment for all transportation services with carriers. The optimization of shipments deserves further description. Some specific tools for optimization of shipments are shown in FIGS. 3A-3B, 4A-4B and 5A-5B.

FIG. 3A illustrates the normal flow of delivery to DC from a vendor. In a first scenario (using an outside carrier), the carrier departs the carrier yard 330, goes to the vendor pickup 340 with an empty truck, loads it, and then proceeds to DC delivery with the load 350. The empty truck then returns to the carrier yard. In a second scenario (using the retailer's dedicated fleet), two simultaneous dispatches leave the DC 360, 380. One is loaded and bound for store delivery 370. One is empty and bound for a vendor pickup 390. The loaded truck returns empty. The empty truck returns loaded. Every empty trip is a potentially wasted opportunity.

Turning to FIG. 3B, the backhaul possibility is illustrated. Instead of having separate trucks doing the store delivery and vendor pickup runs, these can be handled by one truck. The truck leaves the DC 400. It takes its load to the store delivery 410, then on the way back to DC it stops to pickup a load from a nearby vendor 420, making greater usage out of the same trip, same driver and same truck.

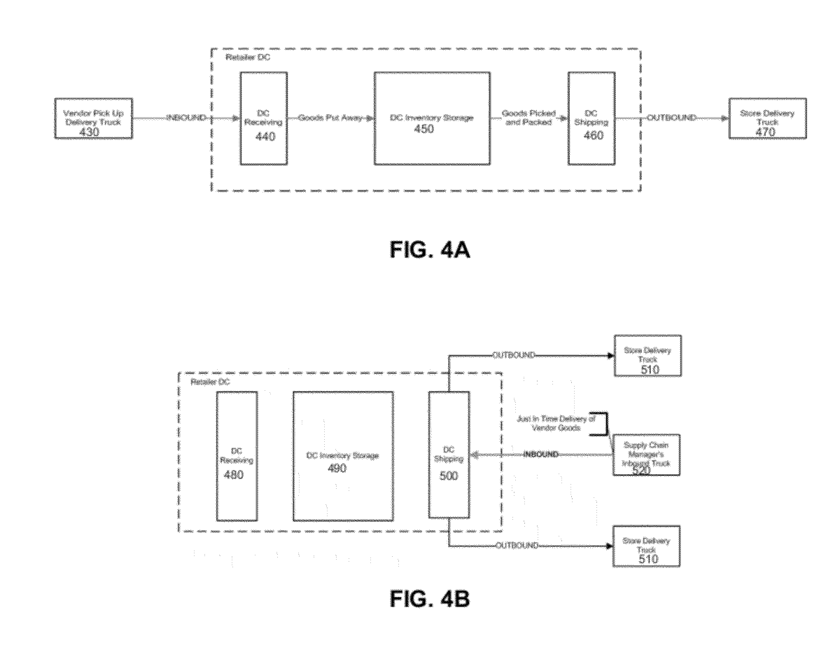

FIG. 4A illustrates the normal DC receiving and shipping process flow from vendor pickup delivery truck into the DC and out to a store delivery truck. After the vendor pickup delivery truck 430 arrives at the retailer DC:
the load is received at DC receiving 440,
the goods are put away into DC inventory storage 450,
the goods are picked and packed for outbound shipping 460, then
the goods are loaded onto a store delivery truck 470 for shipment to the individual store(s).

Turning to FIG. 4B, an alternative mode of interacting with the retailer DC (i.e. a “cross-docking” process) is illustrated. Instead of being delivered a long time in advance of when the goods are actually needed for outbound shipment to stores (which necessitates the storage arrangements and picking and packing illustrated in FIG. 4A), the goods can be delivered into the DC on a just in time basis. The goods actually by-pass the DC receiving 480 and DC inventory storage 490 completely. Instead, the goods come off the supply chain manager's inbound truck 520, go directly to the DC shipping 500 for immediate outbound shipment on store delivery trucks 510. The process enables the warehouse to pick stock for outbound orders directly from the delivered units. This reduces handling, put away and space requirements within the DC.

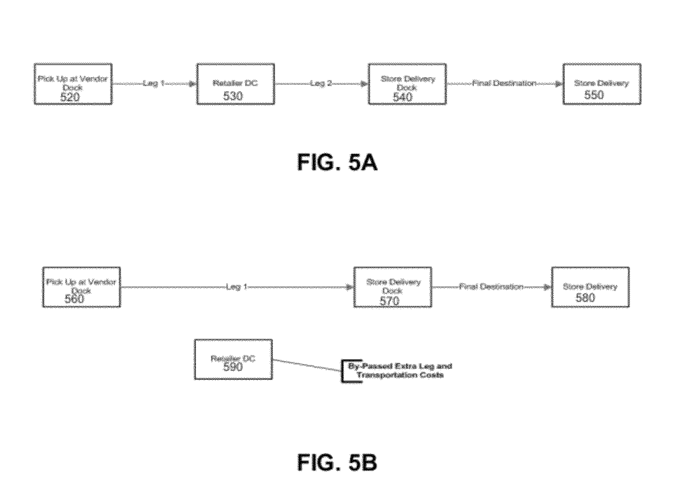

FIG. 5A illustrates the flow of a normal supply chain for delivery to stores from a vendor. The load is picked up at the vendor's dock 520, then brought to the retailer DC 530. On a separate leg, the goods are brought from the DC to the store delivery dock 540 before final delivery at the store 550.

Turning to FIG. 5B, an alternative mode of handling the goods is illustrated (“off-docking”). The goods are still picked up at the vendor dock 560. However, instead of being taken to the retailer DC 590, they can be taken directly to the store delivery dock 570 for final delivery at the store 580. In other words, off-docking is a complete by-pass of the retailer's DC, thus reducing DC handling and space requirements as well as the expense of outbound transportation. For example, this may make sense where the DC is located at a distance away from both the vendor and the destination store, and a shorter trip can be made on a direct route (e.g. vendor located in Toronto, DC in Calgary, store in Winnipeg).

There are other efficiencies gained due to the mere fact of using prearranged vendor pickup appointments and prearranged DC delivery times (as well as the knowledge of the retailer's actual requirements so as to use just-in-time delivery whenever possible).

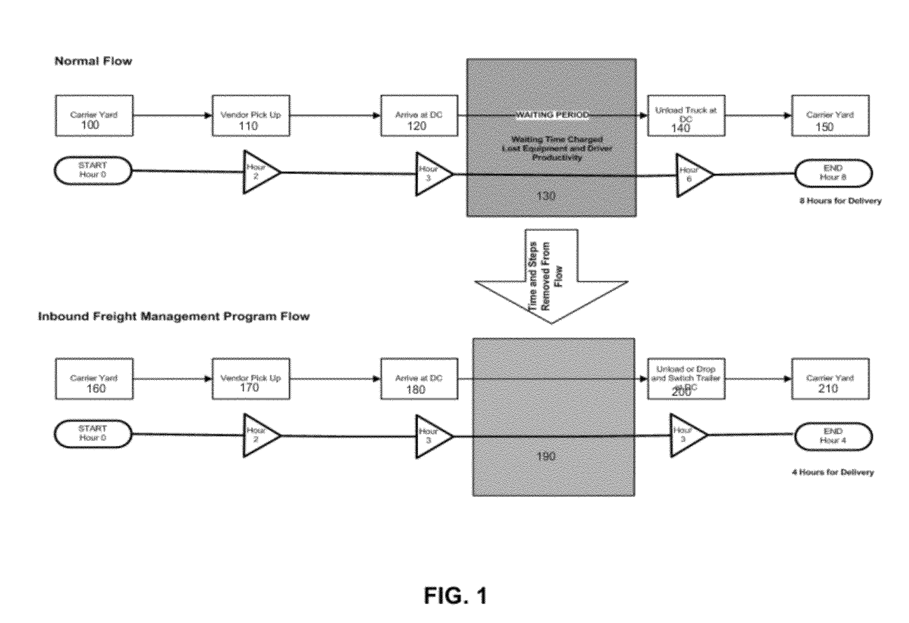

For example, FIG. 1 illustrates the normal flow of a local truck load vendor pickup. At the beginning of the day, the carrier departs the yard (hour 0) 100, he goes to the vendor for pickup (hour 2) 110, arrives at the DC (hour 3) 120 where he waits 130 for a convenient time to unload (hour 6) 140, before finally returning to the carrier yard 150 at hour 8! The entire delivery takes 8 hours. Looking at the second example on FIG. 1, the carrier departs the yard (hour 0) 160, goes to the vendor for pickup (hour 2), arrives at the DC (hour 3). But instead of waiting three hours at the DC, he immediately unloads or drops and switches trailers 200 (by pre-arranged appointment at hour 3), then returns to the carrier yard 210. The box in the middle of the bottom diagram 190 illustrates the hours saved from the flow. Instead of 8 hours, the delivery takes only 4 hours.

This is a gain realized by the manager directly through careful management of the vendor pickup (by appointment) and arrival/unloading at the DC (by appointment), so as not to conflict with other appointments and to ensure load availability for pickup and staff availability at the DC so that the load can be timely unloaded. Also because of the partnership between the manager and the retailer, the manager can take advantage of the “insider” ability to drop and switch trailers (as though his selected carriers were part of the retailer's private fleet).

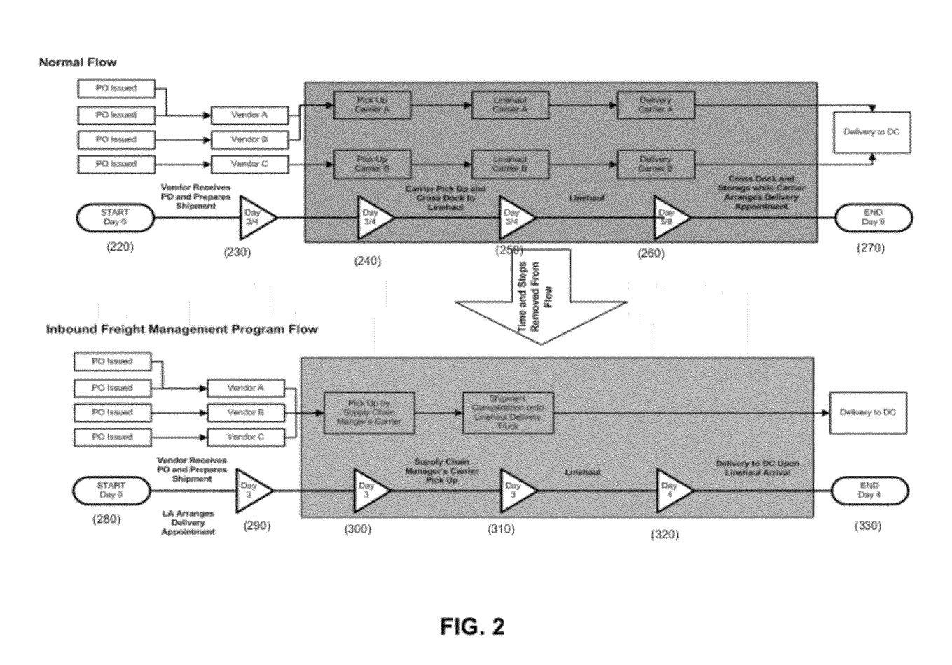

In FIG. 2, another example is illustrated of the inbound less-than-load vendor pickup and delivery to an out of town DC. Looking at the top flow of FIG. 2, purchase orders are issued 220 at Day 0. Each vendor then prepares the shipments for these POs 230 at Day 3/4. Carriers pickup the loads 240. These are then linehauled 250 on separate carriers until Day 5 when they are delivered at the carriers' warehouses 260. The goods spend time at the warehouses while each carrier tries to arrange a delivery appointment (Days 5-8), and the goods are finally delivered to the DC 270 at Day 9.

By contrast, looking at the bottom example, after the POs are issued 280 (at Day 0), the manager arranges pickup and delivery appointments while the vendors are preparing their shipments 290 (Day 0-3). By coordination, all 3 vendors' loads can be picked up on the same date by the manager's selected carrier 300 (Day 3), consolidated and linehauled 310 to arrive at the DC on Day 4 320. The intermediate warehousing is taken out of the flow—a gain of 5 days in this example.

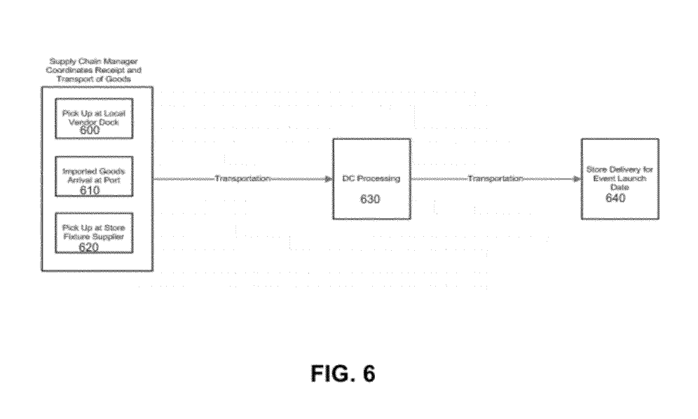

One particular example of how the method can be employed under a particularly high-pressure time-sensitive situation is illustrated in FIG. 6. Retailers often have specific stock requirements for events including seasonal (e.g. Halloween, Christmas), special ad dates (e.g. flyer specials) or new store set up and construction requirements necessitating special handling for a particularly sensitive date or especially high volume of a particular item or selection of items. The supply chain manager coordinates the receipt and transport of goods before they are processed at DC 630 then on to store delivery in time for the launch date 640 of the particular event. As illustrated in the Figure, these goods can come from a variety of sources. In addition to a regular vendor pickup 600, the goods may have come in as imported goods 610 in which case they must be received and processed from the port of arrival. In the case of a new store (or post-construction) setup, the goods may include store fixtures picked up from a fixture supplier 620.

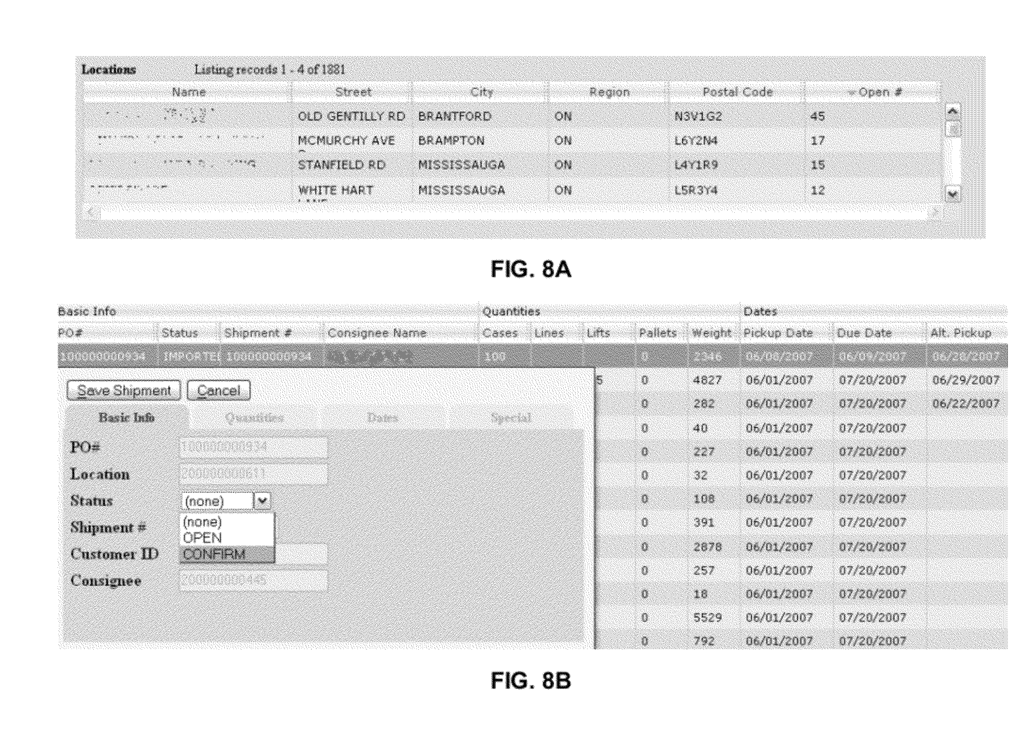

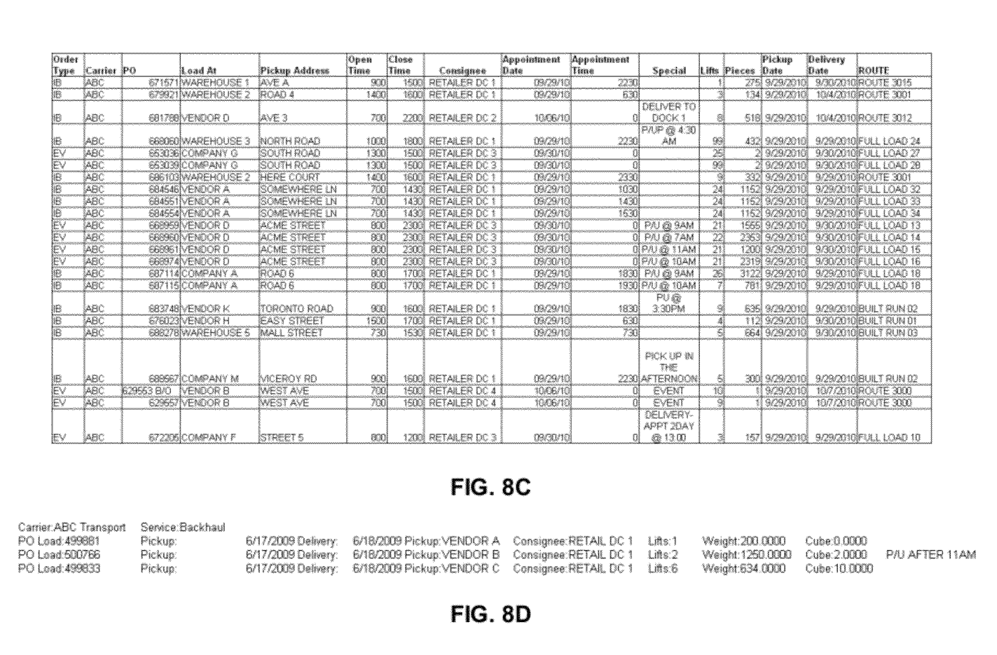

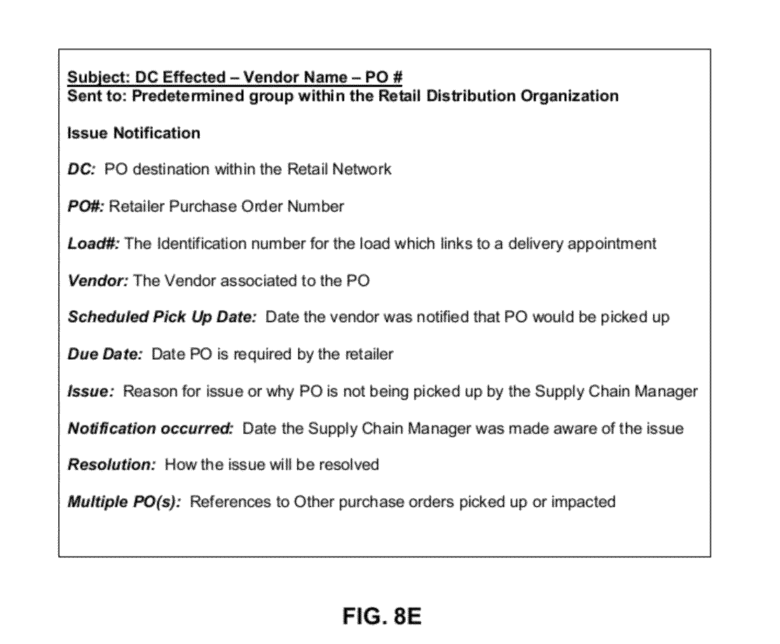

FIGS. 8A-8E illustrate sample views of one possible embodiment of the notification system that may be used with the present method. FIGS. 8A and 8B illustrate views from a vendor notification portal. For example, vendors may receive an email notification that a new purchase order from the retailer has been issued. Purchase orders are sorted by vendor location on the portal. For example, as shown in FIG. 8A, the location selection screen, records are grouped by vendor location. The details of each purchase order including optimized pickup date can also be retrieved as shown in FIG. 8B. The vendor has the opportunity to confirm to the supply chain manager his shipment quantities, any special handling requirements, or the vendor can request an alternative pickup date.

FIG. 8C shows a sample shipment routing report. A daily report, the shipment routing reports list all the pickups due to be made within the next 24 hours from vendor locations. The shipments from this file are then optimized into pickup loads by the supply chain manager to minimize transportation costs and ensure freight will be received at the retailer location at the required time and date.

FIG. 8D shows a sample carrier notification report. The carrier notification report is the daily dispatch file sent to carriers to inform them about the next day's pickups.

It includes pickup appointment times, a list of all purchase orders to be picked up at a vendor location, and any special handling and delivery requirements (including appointment times and dates).

FIG. 8E shows a sample issue notification email template. The issue notification is sent to the retailer (e.g. by email) to inform them if there is any issue related to the pickup of the goods. Issue examples include freight not available for pickup upon arrival of the supply chain manager's carrier, late arrival of a delivery. The supply chain manager will then work with the vendor and the retailer to make arrangements to resolve the issue as soon as possible.

Various configurations of the supporting IT infrastructure are possible. Preferably, the manager uses a transportation management system (TMS) that handles (with advance configuration, as explained elsewhere) incoming purchase orders, load creation, scheduling and report generation. To this is preferably added notification capability (e.g. for exceptions). Preferably, the system also includes separate portals for the retailer, vendors and carriers to each have customized views of the status of their outstanding and completed matters.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

What is claimed is:

1. A method for managing the transportation and logistics of an inbound freight process on behalf of a retail distribution network, the method comprising:
a. processing a purchase order for a planned inbound shipment of a vendor's goods, including a date on which the shipment is required by the retail distribution network;
b. determining an optimal carriage arrangement to meet the date requirement on a just-in-time basis, including proactive reduction of order cycle time where opportunity exists;
c. scheduling a pickup appointment with the vendor, the pickup appointment being notified to the vendor and the retail distribution network;
d. assigning an available carrier, and notifying the carrier as to the scheduled pickup appointment and delivery date requirement;
e. arranging for delivery of the order by the carrier;
f. monitoring the pickup and delivery of the order; and
g. notifying the retail distribution network and the vendor of a successful delivery meeting the delivery date requirement, or notifying the retail distribution network and the vendor if there is a service failure such that the date requirement cannot be met and confirming the resolution (or recovery) plan.

2. The method of claim 1, wherein step (b) includes consolidating multiple purchase orders together, according to preset optimization rules.

3. The method of claim 2, wherein consolidating multiple purchase orders together includes the use of backhaul transportation mode.

4. The method of claim 1, wherein step (c) includes scheduling a specific dock availability window at which the shipment will be available at the vendor's dock.

5. The method of claim 4, wherein step (d) includes finding a carrier available for the specific dock availability window.

6. The method of claim 5, wherein step (d) includes finding a carrier available for the specific dock availability window taking into account backhaul and consolidation opportunities with other purchase orders from the retail distribution network.

7. The method of claim 1, wherein step (f) includes providing retail distribution network and vendor visibility of the current status of the pickup and delivery of the order.

8. The method of claim 1, wherein step (e) includes arranging for delivery to the retail distribution network's distribution centre.

9. The method of claim 8, wherein step (e) includes arranging a short cutting of the linehaul transportation by off docking to the retail distribution network's final store delivery fleet without intermediate storage at the network distribution centre.

10. The method of claim 7, wherein step (e) includes arranging cross docking at the distribution centre for immediate shipment out to one or more of the retail distribution network's stores.

11. The method of claim 1, wherein step (d) further comprises negotiating the lower of a cost of shipment between the vendor and the carrier or retrieving a pre-negotiated rate by the vendor for the shipment.

12. The method of claim 1, wherein step (g) further comprises notifying the retail distribution network and the vendor of a resolution of the service failure.

13. The method of claim 1, wherein the shipment cost is prepaid by the vendor.

14. The method of claim 1, wherein the vendor and the retail distribution network have a pre-existing contractual relationship for supply of product.
